(19) United States
(12) Patent Application Publication
(10) Pub. No.: US 2024/0340383 A1
(43) Pub. Date: Oct. 10, 2024

(54) INFORMATION PROCESSING SYSTEM, MULTIFUNCTION PERIPHERAL COOPERATION METHOD, AND NON-TRANSITORY COMPUTER-READABLE MEDIUM

(71) Applicant: Sharp Kabushiki Kaisha, Sakai City (JP)

(72) Inventors: MASAKI KONDO, Sakai City (JP); Tadashi SAITOH, Sakai City (JP); Asuka BABA, Sakai City (JP); Yoshinori OHTSUKA, Sakai City (JP); Masako SHINOZUKA, Sakai City (JP); Seitarou MORINAGA, Sakai City (JP)

(21) Appl. No.: 18/630,964

(22) Filed: Apr. 9, 2024

(30) Foreign Application Priority Data
Apr. 10, 2023 (JP) 2023-063259

(51) Int. Cl. H04N 1/00

(52) U.S. Cl. CPC H04N 1/00973; H04N 1/00474; H04N 1/0048; H04N 2201/0094

(57) ABSTRACT

An information processing system includes an acceptor that accepts an operation of selecting an execution function from a first function installed in a first multifunction peripheral and a second function not installed in the first multifunction peripheral, and a processing controller that executes the execution function in the first multifunction peripheral when the execution function is the first function, and instructs a second multifunction peripheral in which the second function is installed to execute the execution function when the execution function is the second function.

### CROSS-REFERENCE TO RELATED APPLICATION

The present application claims priority from Japanese Application No. 2023-063259, filed on Apr. 10, 2023, the contents of which are hereby incorporated by reference into this application.

### BACKGROUND

### 1. Field

The present disclosure relates to an information processing system, a multifunction peripheral cooperation method, and a non-transitory computer-readable medium.

### 2. Description of the Related Art

The related art discloses a technique in which, when a desired function is input by a user, a digital multifunction peripheral determines whether the digital multifunction peripheral itself has the function, and if determining that the digital multifunction peripheral itself does not have the function, the digital multifunction peripheral presents a location of an image forming apparatus having the function to the user.

### SUMMARY

In the related art, when a function desired by a user is not installed in a multifunction peripheral to which the function desired by the user is input, it is necessary to operate a multifunction peripheral different from the multifunction peripheral to which the function desired by the user is input. In this case, the user may not be familiar with the user interface of the multifunction peripheral in which the function desired by the user is installed. Therefore, in the related art, it is necessary to perform an operation on a user interface that is unfamiliar to the user, which may be a burden on the user. Accordingly, an object of one aspect of the present disclosure is to provide an information processing system, a multifunction peripheral cooperation method, and a non-transitory computer-readable medium capable of executing a function installed in a plurality of multifunction peripherals by a user's operation in one multifunction peripheral.

An information processing system according to one form of the present disclosure includes an acceptor that accepts an operation of selecting an execution function from a first function installed in a first multifunction peripheral and a second function not installed in the first multifunction peripheral, and a processing controller that executes the execution function in the first multifunction peripheral when the execution function is the first function, and instructs a second multifunction peripheral in which the second function is installed to execute the execution function when the execution function is the second function.

A multifunction peripheral cooperation method according to one form of the present disclosure includes accepting an operation of selecting an execution function from a first function installed in a first multifunction peripheral and a second function not installed in the first multifunction peripheral, and executing the execution function in the first multifunction peripheral when the execution function is the first function, and instructing a second multifunction peripheral in which the second function is installed to execute the execution function when the execution function is the second function.

A non-transitory computer-readable medium according to one form of the present disclosure stores a program that causes a computer to execute a function of accepting an operation of selecting an execution function from a first function installed in a first multifunction peripheral and a second function not installed in the first multifunction peripheral, and a function of performing the execution function in the first multifunction peripheral when the execution function is the first function, and instructing a second multifunction peripheral in which the second function is installed to execute the execution function when the execution function is the second function.

### BRIEF DESCRIPTION OF THE DRAWINGS

FIG. 1 is a diagram illustrating an example of an overall configuration of an information processing system.

FIG. 2 is a block diagram illustrating an example of a configuration of a first multifunction peripheral.

FIG. 3 is a block diagram illustrating an example of a configuration of a second multifunction peripheral.

FIG. 4A is a diagram illustrating an example of a screen for registering the second multifunction peripheral.

FIG. 4B is a diagram illustrating an example of an operation in which the first multifunction peripheral generates a function management list.

FIG. 5 is a diagram illustrating an example of a screen indicating a first function, a screen indicating a function installed in the second multifunction peripheral, and a screen indicating the first function and a second function.

FIG. 6 is a sequence diagram illustrating an example of an operation of the information processing system according to a first embodiment.

FIG. 7 is a sequence diagram illustrating an example of an operation in which a first multifunction peripheral inquires of two second multifunction peripherals about a state.

FIG. 8A is a diagram illustrating an example of an operation of the first multifunction peripheral when the first function is selected as an execution function.

FIG. 8B is a diagram illustrating an example of operations of the first multifunction peripheral and the second multifunction peripheral when the second function is selected as the execution function.

FIG. 9 is a diagram illustrating an example of operations of the first multifunction peripheral and the second multifunction peripheral when a terminal device outputs the processing result of the execution function.

FIG. 10 is a diagram illustrating an example of operations of the first multifunction peripheral and the second multifunction peripheral when a user performs an operation of selecting the execution function with the use of a terminal device.

FIG. 11 is a sequence diagram illustrating an example of an operation of an information processing system according to a second embodiment.

FIG. 12 is a block diagram illustrating an example of a configuration of an information processing system according to a third embodiment.

FIG. 13 is a block diagram illustrating an example of a configuration of a server apparatus according to the third embodiment.

FIG. 14 is a diagram illustrating an example of a function management list according to the third embodiment.

FIG. 15 is a diagram illustrating an example of an operation in which the server apparatus according to the third embodiment generates the function management list.

FIG. 16 is a block diagram illustrating an example of a configuration of a server apparatus according to a fourth embodiment.

FIG. 17 is a diagram illustrating an example of a function management list according to the fourth embodiment.

FIG. 18 is a diagram illustrating an example of an operation in which the server apparatus according to the fourth embodiment generates the function management list.

### DETAILED DESCRIPTION OF THE INVENTION

### First Embodiment

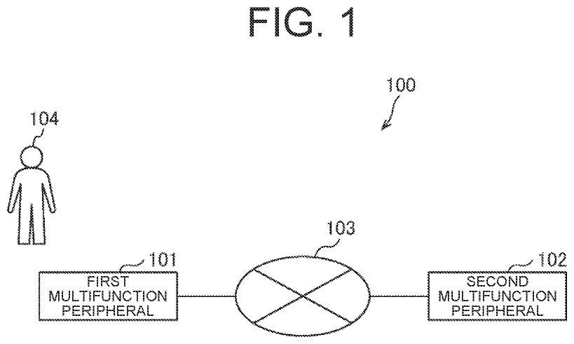

A first embodiment will be described with reference to FIGS. 1 to 10. In the drawings, the same or similar elements are denoted by the same reference numerals, and the redundant description thereof will be omitted.

FIG. 1 is a diagram illustrating an example of an overall configuration of an information processing system 100. The information processing system 100 includes a first multifunction peripheral 101 and a second multifunction peripheral 102. The first multifunction peripheral 101 and the second multifunction peripheral 102 are connected via a network 103. The network 103 is the Internet, a local area network (LAN), or the like. The information processing system 100 may include two or more second multifunction peripherals 102.

The first multifunction peripheral 101 is a multifunction peripheral operated by a user 104. The second multifunction peripheral 102 is a multifunction peripheral in which a function that is not installed in the first multifunction peripheral 101 is installed.

When the first multifunction peripheral 101 accepts an operation of selecting a first function from a first function installed in the first multifunction peripheral 101 and a second function not installed in the first multifunction peripheral 101, the first multifunction peripheral 101 executes the selected first function. Further, when the first multifunction peripheral 101 accepts an operation of selecting the second function from the first function and the second function, the first multifunction peripheral 101 instructs the second multifunction peripheral 102 to execute the selected second function. Thus, the information processing system 100 allows the user 104 to use the first multifunction peripheral 101, allows the user 104 to select a function installed in the first multifunction peripheral 101 or a function not installed in the first multifunction peripheral 101, and allows a multifunction peripheral having the selected function installed therein to execute the selected function.

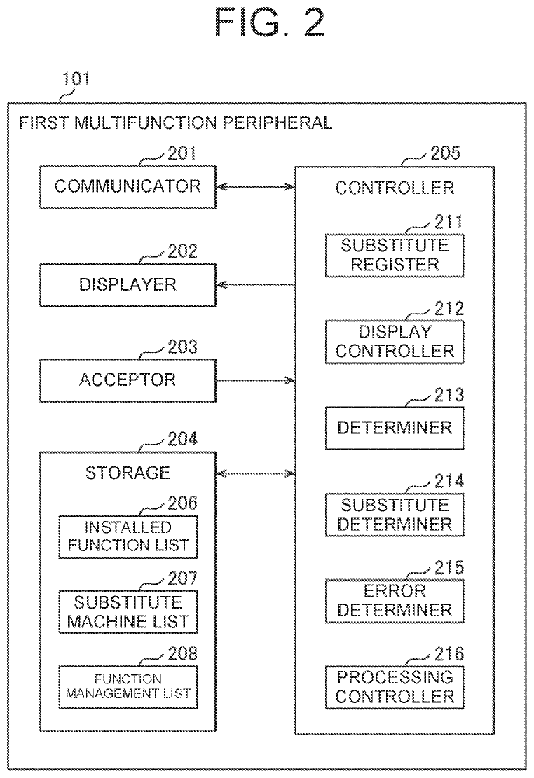

FIG. 2 is a block diagram illustrating an example of a configuration of the first multifunction peripheral 101. The first multifunction peripheral 101 includes a communicator 201, a displayer 202, an acceptor 203, a storage 204, and a controller 205.

The communicator 201 is an interface connected to the network 103.

The displayer 202 displays information to be presented to the user 104. Specifically, the displayer 202 displays a screen for selecting an execution function from the first function installed in the first multifunction peripheral 101 and the second function not installed in the first multifunction peripheral 101. For example, the displayer 202 is constituted by a liquid crystal panel, an organic electro-luminescence (EL) panel, or the like.

The acceptor 203 accepts an operation of selecting an execution function from the first function and the second function. For example, the acceptor 203 is constituted by a touch panel.

The storage 204 is a recording medium capable of recording various kinds of data, programs, and the like. For example, the storage 204 is configured with a hard disk drive (HDD), a solid state drive (SSD), a semiconductor memory, or the like. The storage 204 stores an installed function list 206, a substitute machine list 207, and a function management list 208. A list of the first functions is registered in the installed function list 206. In the substitute machine list 207, the identification information of the second multifunction peripheral 102 is registered in association with the priority. In the function management list 208, the first function, the second function, the identification information of the second multifunction peripheral 102 in which the second function is installed, and the priority associated with the identification information of the second multifunction peripheral 102 are associated and registered. For example, the identification information of the second multifunction peripheral 102 is an Internet Protocol (IP) address assigned to the second multifunction peripheral 102.

The controller 205 executes various processing in accordance with the programs and data stored in the storage 204. For example, the controller 205 is configured with a processor such as a central processing unit (CPU). The controller 205 includes a substitute register 211, a display controller 212, a determiner 213, a substitute determiner 214, an error determiner 215, and a processing controller 216.

The substitute register 211 registers a function installed in the second multifunction peripheral 102 and the second multifunction peripheral 102 in association with each other.

The display controller 212 causes the displayer 202 to display the first function and the second function in a selectable manner. Further, the display controller 212 causes the displayer 202 to display the first function and the second function in a distinguishable manner. In other words, the display controller 212 causes the displayer 202 to display a function installed in the first multifunction peripheral 101 and a function not installed in the first multifunction peripheral 101 in a selectable and distinguishable manner.

The determiner 213 determines whether the execution function is the first function. That is, the determiner 213 determines whether a function installed in the first multifunction peripheral 101 has been selected.

When the execution function is the second function, the substitute determiner 214 determines whether there is the second multifunction peripheral 102. That is, when a function that is not installed in the first multifunction peripheral 101 is selected, the substitute determiner 214 determines whether there is a multifunction peripheral in which the selected function is installed.

When the execution function is the first function, the error determiner 215 determines whether the first multifunction peripheral 101 is capable of executing the execution function. That is, when a function installed in the first multifunction peripheral 101 is selected, the error determiner 215 determines whether the first multifunction peripheral 101 is capable of executing the selected function.

When the execution function is the first function, the processing controller 216 executes the execution function in the first multifunction peripheral 101, and when the execution function is the second function, instructs the second multifunction peripheral 102 in which the second function is installed to execute the execution function. That is, when a function installed in the first multifunction peripheral 101 is selected, the processing controller 216 executes the selected function in the first multifunction peripheral 101. On the other hand, when a function that is not installed in the first multifunction peripheral 101 is selected, the processing controller 216 instructs the second multifunction peripheral 102 in which the selected function is installed to execute the selected function.

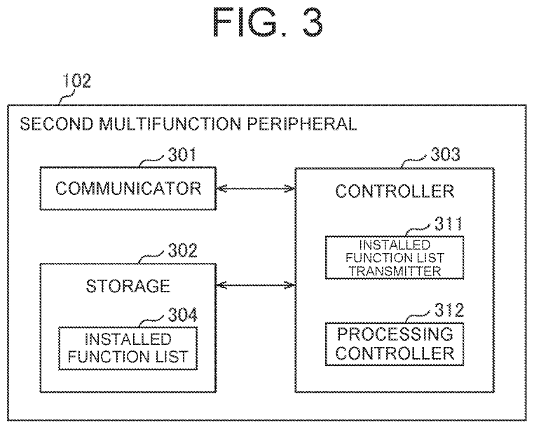

FIG. 3 is a block diagram illustrating an example of a configuration of the second multifunction peripheral 102. The second multifunction peripheral 102 includes a communicator 301, a storage 302, and a controller 303.

The communicator 301 is an interface connected to the network 103.

The storage 302 is a recording medium capable of recording various kinds of data, programs, and the like. For example, the storage 302 is configured with an HDD, an SSD, a semiconductor memory, or the like. The storage 302 stores an installed function list 304. A list of functions installed in the second multifunction peripheral 102 is registered in the installed function list 304.

The controller 303 executes various processing in accordance with the programs and data stored in the storage 302. For example, the controller 303 is configured with a processor such as a CPU. The controller 303 includes an installed function list transmitter 311 and a processing controller 312.

The installed function list transmitter 311 transmits the installed function list 304 to the first multifunction peripheral 101.

The processing controller 312 executes a function installed in the second multifunction peripheral 102.

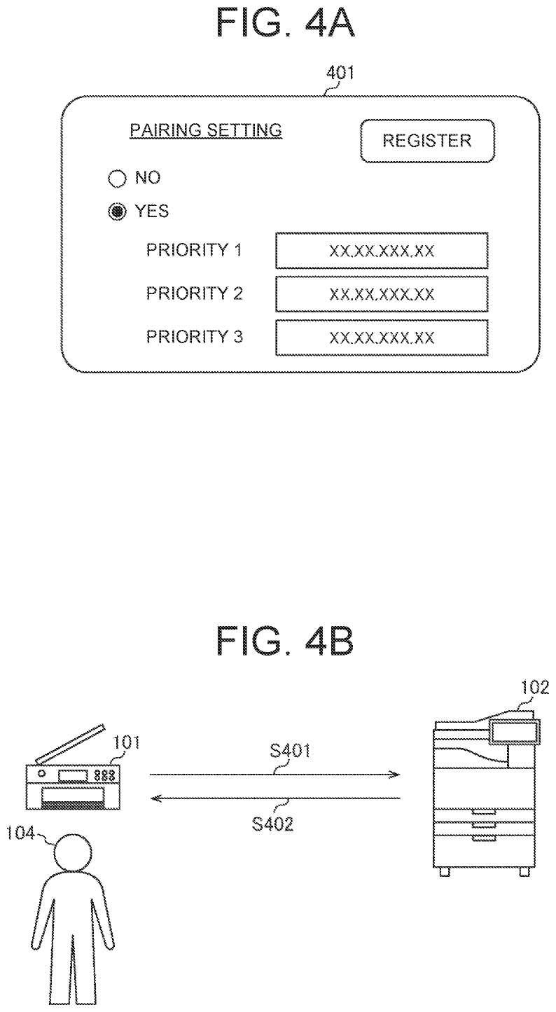

FIG. 4A is a diagram illustrating an example of a screen 401 for registering the second multifunction peripheral 102. The screen 401 is a screen on which an IP address assigned to the second multifunction peripheral 102 to be registered can be input. Specifically, on the screen 401, the identification information of the second multifunction peripheral 102 can be input for each priority.

When the acceptor 203 accepts an operation of starting registration of the second multifunction peripheral 102, the display controller 212 causes the displayer 202 to display the screen 401. When the acceptor 203 accepts an operation of inputting the identification information of the second multifunction peripheral 102, the substitute register 211 associates an IP address indicating the input identification information of the second multifunction peripheral 102 with the priority, and registers the IP address in the substitute machine list 207.

A terminal device different from the first multifunction peripheral 101 may accept an operation of starting the registration of the second multifunction peripheral 102 and cause the displayer of the device to display the screen 401. In this case, the device associates the input identification information of the second multifunction peripheral 102 with the priority, and transmits the identification information to the first multifunction peripheral 101. Then, the substitute register 211 associates the identification information of the second multifunction peripheral 102 transmitted from the device with the priority, and registers the identification information in the substitute machine list 207.

FIG. 4B is a diagram illustrating an example of an operation in which the first multifunction peripheral 101 generates the function management list 208. It is assumed that the first function is registered in the function management list 208 at the time when the controller 205 starts the processing of step S401. Further, it is assumed that the identification information of the second multifunction peripheral 102 is registered in the substitute machine list 207 in association with the priority at the time when the controller 205 starts the processing of step S401.

In step S401, the substitute register 211 inquires of the second multifunction peripheral 102 having the identification information registered in the substitute machine list 207 about the functions installed in the second multifunction peripheral 102. In step S402, when the second multifunction peripheral 102 receives an inquiry about the functions installed in the second multifunction peripheral 102, the installed function list transmitter 311 responds with a list of functions indicated by the installed function list 304. Then, the substitute register 211 registers the list of functions transmitted from the second multifunction peripheral 102, the identification information of the second multifunction peripheral 102, and the priority of the second multifunction peripheral 102 in the function management list 208 in association with one another.

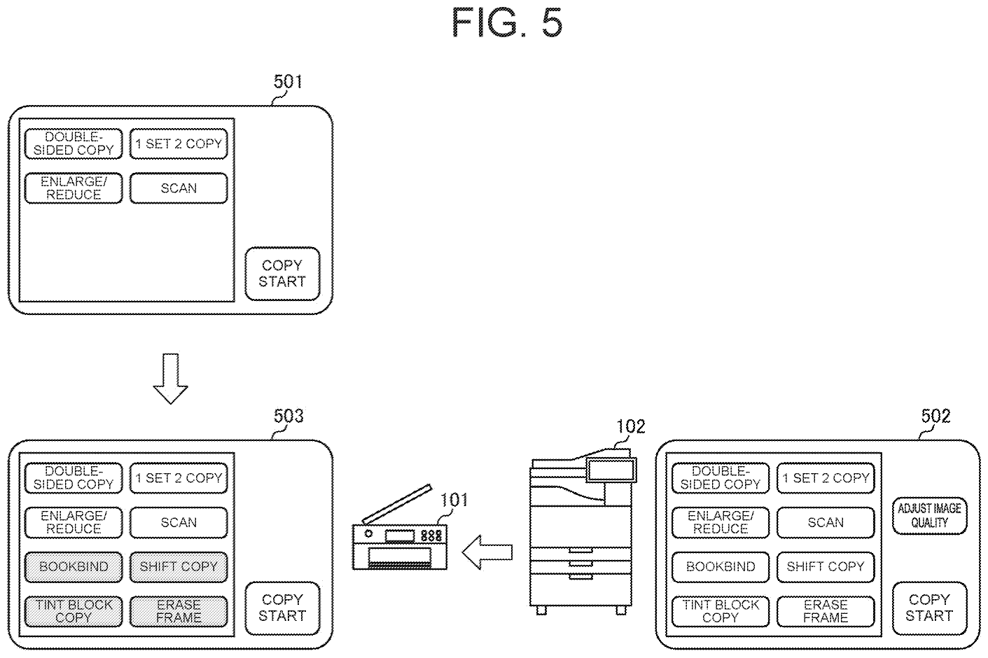

FIG. 5 is a diagram illustrating an example of a screen 501 indicating the first function, a screen 502 indicating a function installed in the second multifunction peripheral 102, and a screen 503 indicating the first function and the second function. The screen 501 and the screen 503 are screens displayed on the displayer 202 of the first multifunction peripheral 101. The screen 502 is a screen displayed on a displayer (not illustrated) of the second multifunction peripheral 102.

For example, it is assumed that the first multifunction peripheral 101 has a double-sided copy function, an enlargement/reduction function, a 1 set 2 copy function, and a scan function. That is, the double-sided copy function, the enlargement/reduction function, the 1 set 2 copy function, and the scan function are the first function. In this case, the screen 501 includes a double-sided copy button, an enlargement/reduction button, a 1 set 2 copy button, and a scan button.

Further, it is assumed that the second multifunction peripheral 102 has the double-sided copy function, the 1 set 2 copy function, the enlargement/reduction function, the scan function, a bookbinding function, a shift copy function, a tint block copy function, and a frame erasing function. In this case, the screen 502 includes the double-sided copy button, the 1 set 2 copy button, the enlargement/reduction button, the scan button, a bookbinding button, a shift copy button, a tint block copy button, a frame erasing button, and an image quality adjustment button. The bookbinding function, the shift copy function, the tint block copy function, the frame erasing function, and an image quality adjustment function are second functions that are not installed in the first multifunction peripheral 101 but are installed in the second multifunction peripheral 102.

When the substitute register 211 registers the first function and the second function in the function management list 208, the display controller 212 causes the screen 503 to include the double-sided copy button, the enlargement/reduction button, the 1 set 2 copy button, the scan button, the bookbinding button, the shift copy button, the tint block copy button, and the frame erasing button. Thus, the information processing system 100 allows the user 104 to perform an operation of selecting the bookbinding function, the shift copy function, the tint block copy function, and the frame erasing function, which are not installed in the first multifunction peripheral 101, by using the first multifunction peripheral 101. The display controller 212 may cause the displayer 202 to display the first function and the second function in a distinguishable manner. For example, as illustrated in the screen 503, the display controller 212 causes the displayer 202 to display the button indicating the bookbinding function, the button indicating the shift copy function, the button indicating the tint block copy function, and the button indicating the frame erasing function in a color different from that of the button indicating the double-sided copy function, the button indicating the 1 set 2 copy function, the button indicating the enlargement/reduction function, and the button indicating the scan function.

Further, the display controller 212 causes the displayer 202 to display, for the second function, a function that requires an operation in the second multifunction peripheral 102 and a function that does not require an operation in the second multifunction peripheral 102 in a distinguishable manner.

For example, it is assumed that the first multifunction peripheral 101 does not have an outputter that outputs the processing result of the bookbinding function. In this case, as illustrated in the screen 503, the display controller 212 causes the displayer 202 to display the bookbinding function in a color different from that of the button indicating the function by which the processing result can be output by the first multifunction peripheral 101. Alternatively, the display controller 212 may cause the displayer 202 to display the bookbinding function with an icon having a shape different from that of the button indicating the function by which the processing result can be output by the first multifunction peripheral 101, a color of characters, or the like. This allows the user 104 to visually recognize that the first multifunction peripheral 101 does not output the processing result.

Further, the display controller 212 causes the displayer 202 to display, for the second function, a function that can be operated in the first multifunction peripheral 101 and a function that cannot be operated in the first multifunction peripheral 101 in a distinguishable manner.

For example, it is assumed that the image quality adjustment function is not installed in the first multifunction peripheral 101 and cannot be operated in the first multifunction peripheral 101. In this case, the display controller 212 does not display the image quality adjustment function on the displayer 202, as illustrated in the screen 503. As a result, the information processing system 100 can prevent a function that cannot be operated in the first multifunction peripheral 101 from being presented to the user 104.

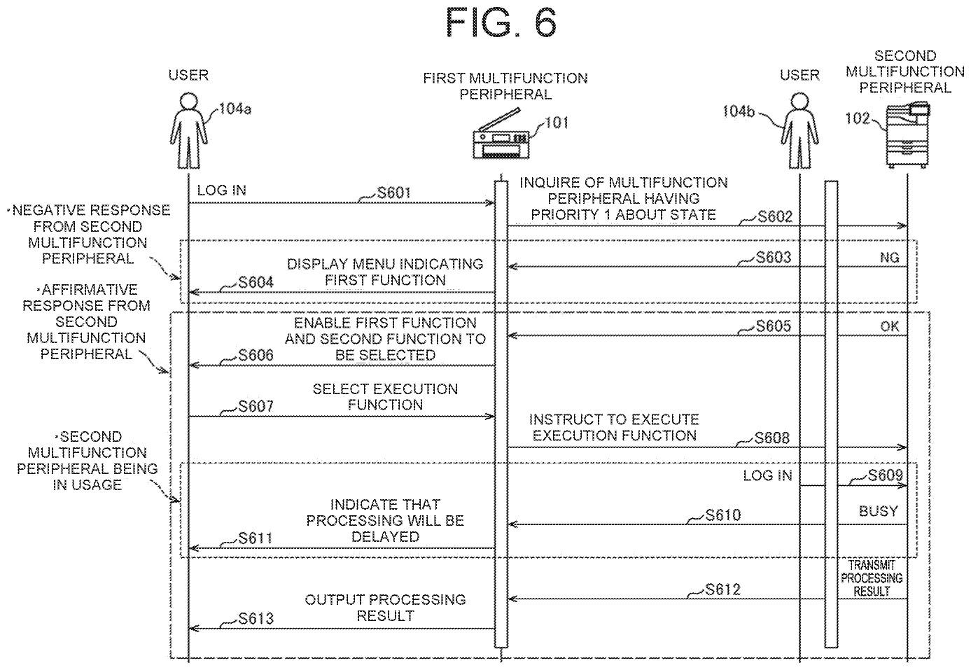

FIG. 6 is a sequence diagram illustrating an example of an operation of the information processing system 100 according to the present embodiment. It is assumed that the identification information of the second multifunction peripheral 102 is registered in the substitute machine list 207 in association with a priority 1 indicating the highest priority, at the time when the controller 205 starts the processing of step S601. Further, it is assumed that, at the time when the controller 205 starts the processing of step S601, the first function, the second function, the identification information of the second multifunction peripheral 102 in which the second function is installed, and the priority of the second multifunction peripheral 102 are registered in the function management list 208 in association with one another.

In step S601, when the acceptor 203 accepts a login operation by a user 104a who operates the first multifunction peripheral 101 and accepts an operation of selecting an execution function, the determiner 213 determines whether the execution function is the first function. That is, the determiner 213 determines whether a function installed in the first multifunction peripheral 101 operated by the user 104 is selected.

The display controller 212 may cause the displayer 202 to display a function that can be executed in the first multifunction peripheral 101 and a function that cannot be executed in the first multifunction peripheral 101 in a distinguishable manner.

For example, in the first multifunction peripheral 101, it is assumed that the copy function as the first function cannot be executed due to running out of toner. In this case, the display controller 212 causes the displayer 202 to display the copy button indicating the copy function in a color, an icon, a character color, or the like different from those of buttons indicating other functions. Thus, the information processing system 100 allows the user 104a to distinguish between a function that can be executed in the first multifunction peripheral 101 and a function that cannot be executed in the first multifunction peripheral 101.

It is assumed that the execution function is the first function, and the error determiner 215 determines that the first multifunction peripheral 101 cannot execute the execution function. For example, in a case where the execution function is the copy function which is the first function, and the copy function cannot be executed due to running out of toner in the first multifunction peripheral 101, the error determiner 215 determines that the first multifunction peripheral 101 cannot execute the execution function. In this case, the substitute determiner 214 determines whether there is a multifunction peripheral that can execute the execution function.

Alternatively, when the execution function is the second function, the substitute determiner 214 inquires of the second multifunction peripheral 102 having the identification information associated with the priority 1 about the state of the second multifunction peripheral 102 in step S602. That is, when a function that is not installed in the first multifunction peripheral 101 is selected, the substitute determiner 214 inquires of the second multifunction peripheral 102 having the identification information associated with the priority 1 about the state of the second multifunction peripheral 102 in step S602.

Here, if the second multifunction peripheral 102 is not operable, the substitute determiner 214 determines in step S603 that the second multifunction peripheral 102 is not operable. For example, when the power of the second multifunction peripheral 102 is off, the second multifunction peripheral 102 is not operable. In this case, in step S604, the display controller 212 causes the displayer 202 to display only the first function without causing the displayer 202 to display the second function. Therefore, when the second multifunction peripheral 102 is not operable, the user 104a cannot perform the operation of selecting the second function, and can perform only the operation of selecting the first function.

On the other hand, if the second multifunction peripheral 102 is operable, the controller 303 responds that the second multifunction peripheral 102 is operable. Then, in step S605, the substitute determiner 214 determines that the second multifunction peripheral 102 is operable. For example, when the power of the second multifunction peripheral 102 is on, the second multifunction peripheral 102 is operable. In this case, in step S606, the display controller 212 causes the displayer 202 to display the first function and the second function installed in the second multifunction peripheral 102 having the identification information associated with the priority 1.

In step S607, when the acceptor 203 accepts an operation of selecting the second function as the execution function, the substitute determiner 214 determines whether there is a multifunction peripheral that can execute the execution function. For example, when the second multifunction peripheral 102 having the identification information associated with the priority 1 is operable, the substitute determiner 214 determines that the second multifunction peripheral 102 can execute the execution function.

In step S608, the processing controller 216 instructs the second multifunction peripheral 102 having the identification information associated with the priority 1 to execute the execution function. Specifically, the processing controller 216 transmits document data for executing the execution function and an instruction to execute the execution function to the second multifunction peripheral 102. Here, it is assumed that the first multifunction peripheral 101 includes an outputter that outputs the processing result of the execution function.

It is assumed that, in step S608, after the processing controller 216 instructs the second multifunction peripheral 102 to execute the execution function, in step S609, a user 104b who operates the second multifunction peripheral 102 logs in. At this time, it is assumed that the second multifunction peripheral 102 is in a busy state in which the processing of executing the function is being executed. In this case, in step S610, the processing controller 312 notifies the first multifunction peripheral 101 that the second multifunction peripheral 102 is in the busy state. Then, in step S611, the display controller 212 causes the displayer 202 to display a message indicating that the processing will be delayed in the second multifunction peripheral 102. As a result, the information processing system 100 allows the user 104a to visually recognize that the processing will be delayed.

When the busy state is resolved in the second multifunction peripheral 102, the processing controller 312 executes the execution function instructed in step S608, and transmits the processing result to the first multifunction peripheral 101 in step S612. Then, in step S613, the processing controller 216 outputs the received processing result.

For example, in a case where the user 104 is accustomed to the operation of the first multifunction peripheral 101 and is unfamiliar with the operation of the second multifunction peripheral 102, there is a concern that the operation of the second multifunction peripheral 102 will be a burden on the user 104. However, the information processing system 100 can execute a function installed in the second multifunction peripheral 102 by an operation of the user 104 in the first multifunction peripheral 101. As a result, the information processing system 100 can provide the user 104 with the processing results of the functions installed in the plurality of multifunction peripherals while reducing the burden on the user 104.

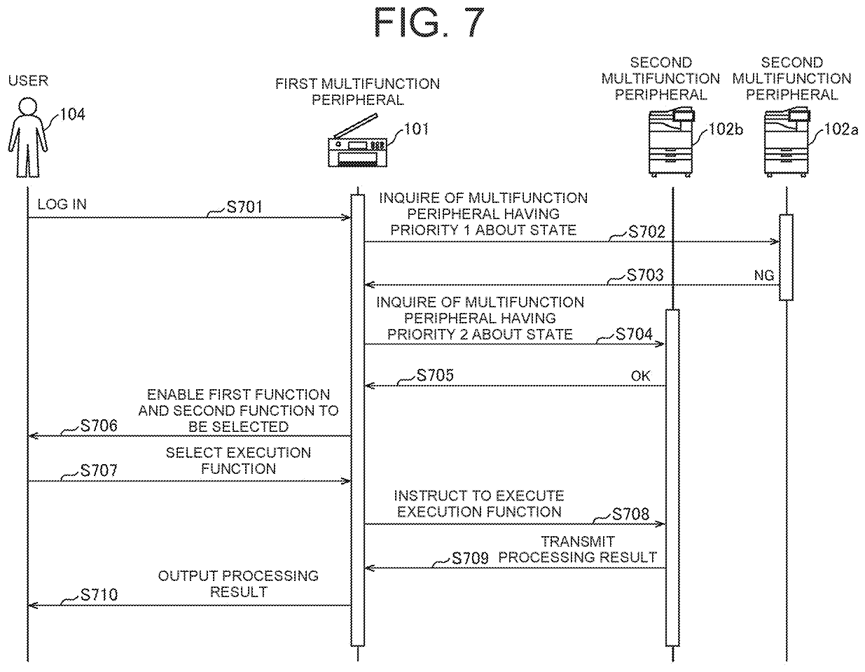

FIG. 7 is a sequence diagram illustrating an example of an operation in which the first multifunction peripheral 101 inquires of a second multifunction peripheral 102a and a second multifunction peripheral 102b about the state. It is assumed that, at the time when the controller 205 starts the processing of step S701, the identification information of the second multifunction peripheral 102a is registered in association with a priority 1 and the identification information of the second multifunction peripheral 102b is registered in association with a priority 2 indicating the second highest priority in the substitute machine list 207. Further, it is assumed that, at the time when the controller 205 starts the processing of step S701, the first function, the second function, the identification information of each of the second multifunction peripherals 102a and 102b in which the second function is installed, and the priorities associated with identification information of each of the second multifunction peripherals 102a and 102b are registered in the function management list 208 in association with one another. The processing of step S701 is the same as the processing of step S601 illustrated in FIG. 6, and thus the detailed description thereof will be omitted.

When the execution function selected in step S701 is the second function, the substitute determiner 214 inquires of the second multifunction peripheral 102a having the identification information associated with the priority 1 about the state of the second multifunction peripheral 102a in step S702.

When the substitute determiner 214 determines in step S703 that the second multifunction peripheral 102a is not operable, the substitute determiner 214 inquires of the second multifunction peripheral 102b having the identification information associated with the priority 2 about the state of the second multifunction peripheral 102b in step S704. When the second multifunction peripheral 102b is operable, the controller 303 responds that the second multifunction peripheral 102b is operable.

Then, in step S705, the substitute determiner 214 determines that the second multifunction peripheral 102b is operable. Then, the controller 205 shifts the processing to step S706. The processing from step S706 to step S710 is the same as the processing from step S606 to step S608 and from step S612 to step S613 illustrated in FIG. 6, and thus the detailed description thereof will be omitted.

When the processing from step S706 to step S710 is executed, in the information processing system 100, the first multifunction peripheral 101 instructs the second multifunction peripheral 102b associated with the priority 2 to execute the execution function.

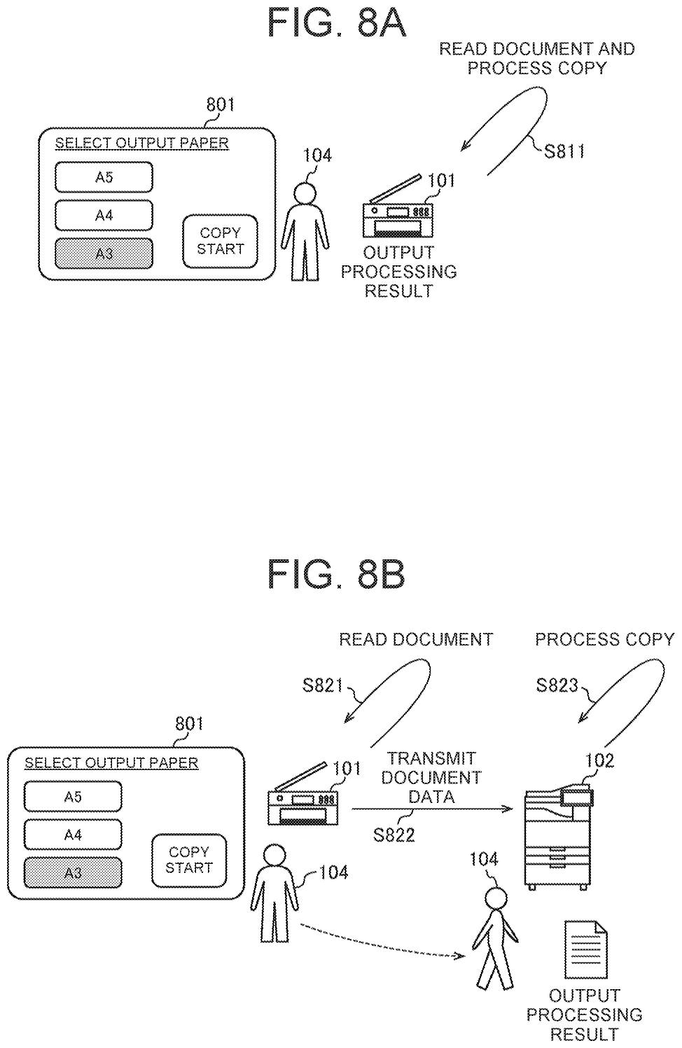

FIG. 8A is a diagram illustrating an example of an operation of the first multifunction peripheral 101 when the first function is selected as the execution function. FIG. 8B is a diagram illustrating an example of operations of the first multifunction peripheral 101 and the second multifunction peripheral 102 when the second function is selected as the execution function. The first multifunction peripheral 101 and the second multifunction peripheral 102 illustrated in FIG. 8A include a reader that reads a document, a copier that copies and prints the read document, and an outputer that outputs a sheet on which the document data is printed.

A screen 801 is a screen displayed on the displayer 202 of the first multifunction peripheral 101. For example, it is assumed that the first multifunction peripheral 101 is provided with an A5 copy function and an A4 copy function. In addition, it is assumed that the second multifunction peripheral 102 is provided with an A3 copy function. In this case, the screen 801 includes an A5 copy button, an A4 copy button, and an A3 copy button.

When the acceptor 203 accepts an operation of selecting the A4 copy function, which is the first function, as the execution function, the processing controller 216 executes the A4 copy function in step S811. Specifically, the processing controller 216 reads a document and prints the read document data on an A4 size sheet. Then, the processing controller 216 executes the processing for outputting the printed A4 size sheet.

The display controller 212 causes the displayer 202 to display, for the second function, a function that requires an operation in the second multifunction peripheral 102 and a function that does not require an operation in the second multifunction peripheral 102 in a distinguishable manner. For example, the A3 copy function requires an operation of feeding an A3 size sheet to the second multifunction peripheral 102, and thus the A3 copy function requires an operation in the second multifunction peripheral 102. Therefore, as illustrated in the screen 801, the display controller 212 causes the displayer 202 to display the A3 copy button in a color different from that of the A5 copy button and the A4 copy button. As a result, the information processing system 100 allows the user 104 to visually recognize that the A3 copy function needs to be operated in the second multifunction peripheral 102.

When the acceptor 203 accepts an operation of selecting the A3 copy function, which is the second function, as the execution function, the processing controller 216 reads a document in step S821. Since the A3 copy function is not installed in the first multifunction peripheral 101, the processing controller 216 transmits the read document data to the second multifunction peripheral 102 in step S822. In step S823, the processing controller 312 executes the A3 copy function. Specifically, the processing controller 312 executes the processing for printing a document data on an A3 size sheet. Then, the user 104 goes to the location where the second multifunction peripheral 102 is installed to pick up the printed A3 size sheet.

In addition, in a case where an operation in the second multifunction peripheral 102 is necessary for the execution function, the processing controller 216 may notify the location where the second multifunction peripheral 102 that executes the execution function is installed. For example, the processing controller 216 may notify the location where the second multifunction peripheral 102 is installed by causing the displayer 202 to display a map indicating the location where the second multifunction peripheral 102 is installed. Alternatively, in a case where the first multifunction peripheral 101 includes a speaker, the processing controller 216 may cause the speaker to output a sound indicating the location where the second multifunction peripheral 102 is installed. Thus, the information processing system 100 can notify the user 104 of the location where the second multifunction peripheral 102 is installed when a function that requires an operation in the second multifunction peripheral 102 is executed.

In a case where the execution function can be executed and an operation is necessary in the plurality of second multifunction peripherals 102, the processing controller 216 may instruct the second multifunction peripheral 102 installed at a position closest to the first multifunction peripheral 101 among the plurality of second multifunction peripherals 102 to execute the execution function. For example, in a case where the plurality of second multifunction peripherals 102 have the A3 copy function, the processing controller 216 instructs the second multifunction peripheral 102 installed at a position closest to the first multifunction peripheral 101 among the plurality of second multifunction peripherals 102 to execute the A3 copy function. In this case, the user 104 goes to the location where the second multifunction peripheral 102 installed at a position closest to the first multifunction peripheral 101 to pick up the printed A3 size sheet. Therefore, the information processing system 100 can improve the convenience of the user 104 as compared with a case where the second multifunction peripheral 102 installed at a position relatively distant from the first multifunction peripheral 101 is caused to execute the execution function.

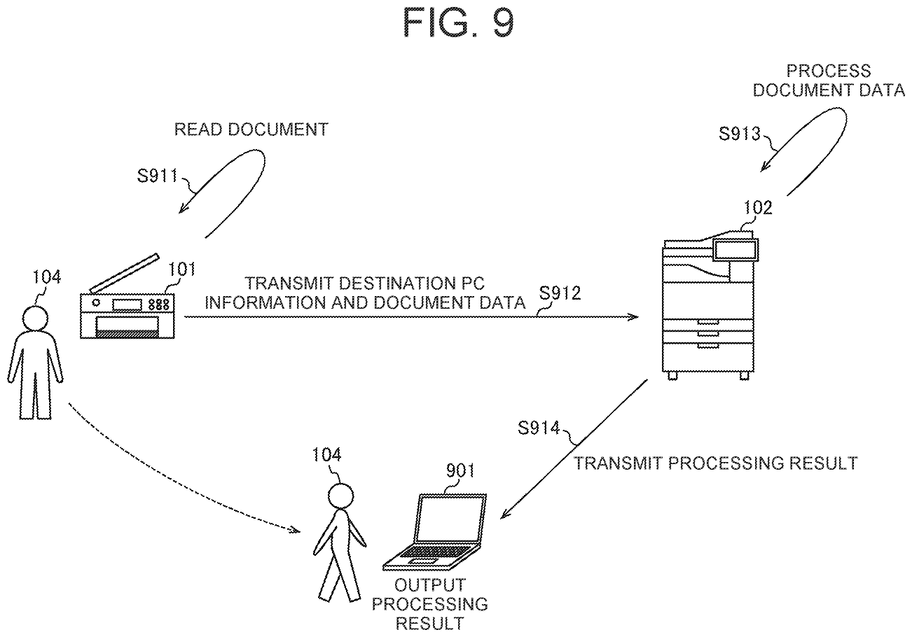

FIG. 9 is a diagram illustrating an example of operations of the first multifunction peripheral 101 and the second multifunction peripheral 102 when a terminal device 901 outputs the processing result of the execution function. Specifically, in the operation illustrated in FIG. 9, the execution function that is the second function is a function of processing document data, and the second multifunction peripheral 102 processes the document data and transmits same to the terminal device 901. For example, the terminal device 901 is a personal computer (PC), a smartphone, or the like.

When the acceptor 203 accepts an operation of selecting a document data processing function as the execution function, the processing controller 216 reads a document in step S911. Here, the function of processing the document data indicating the read document is a function that is not installed in the first multifunction peripheral 101. In step S912, the processing controller 216 transmits the document data and the information for identifying the terminal device 901 to the second multifunction peripheral 102. For example, the information for identifying the terminal device 901 is a mail address, an IP address assigned to the terminal device 901, or the like.

In step S913, the processing controller 312 performs processing of processing the document data transmitted from the first multifunction peripheral 101. For example, the processing of processing the document data is processing of removing a region including a color image and cutting out a region including characters from the document data. In step S914, the processing controller 312 transmits the processing result of step S913 to the terminal device 901. As a result, the information processing system 100 can provide the user 104 with the processing result of the function installed in the second multifunction peripheral 102 without causing the user 104 to operate the second multifunction peripheral 102.

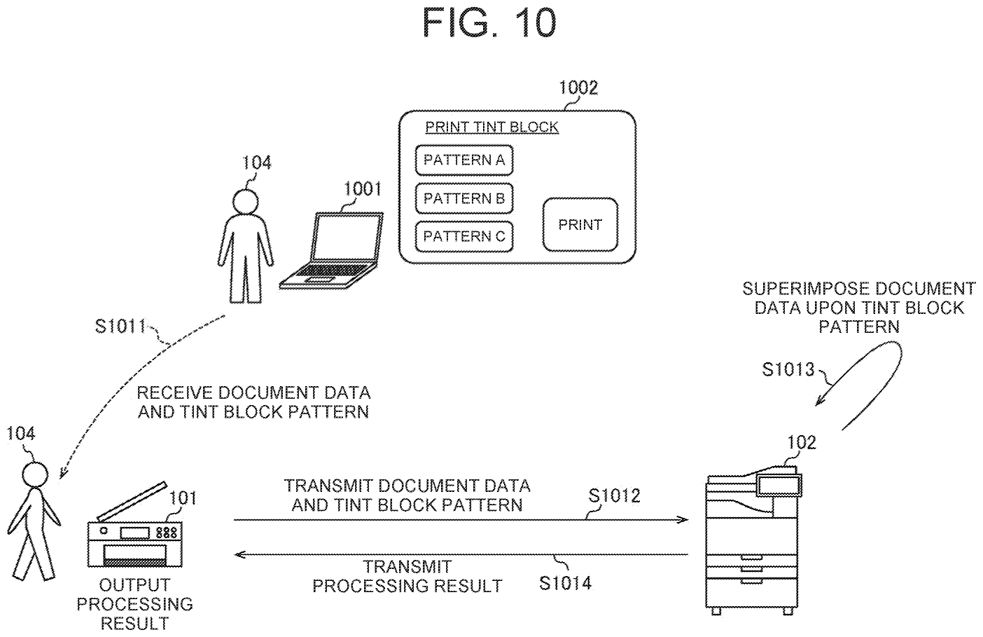

FIG. 10 is a diagram illustrating an example of operations of the first multifunction peripheral 101 and the second multifunction peripheral 102 when the user 104 performs an operation of selecting the execution function with the use of a terminal device 1001. A screen 1002 is a screen displayed on the terminal device 1001. The screen 1002 includes a button related to a function of combining a tint block pattern with document data. In the operation illustrated in FIG. 10, a function of combining a tint block pattern with document data, which is the second function, is selected as the execution function by an operation on the terminal device 1001, and the first multifunction peripheral 101 outputs the processing result of the execution function. For example, the terminal device 1001 is a PC, a smartphone, or the like.

When the terminal device 1001 accepts an operation of selecting document data and a tint block pattern, the terminal device 1001 transmits the selected document data and the selected tint block pattern to the first multifunction peripheral 101 in step S1011. The first multifunction peripheral 101 is not provided with the function of combining a tint block pattern with document data, the processing controller 216 transmits the document data and the tint block pattern to the second multifunction peripheral 102 in step S1012. In step S1013, the processing controller 312 executes the processing of combining the document data with the tint block pattern transmitted from the first multifunction peripheral 101.

In step S1014, the processing controller 312 transmits the combined data of the document data and the tint block pattern, which is the processing result of step S1013, to the first multifunction peripheral 101. Then, the processing controller 216 executes the processing for printing the combined data of the document data and the tint block pattern transmitted from the second multifunction peripheral 102. Then, the user 104 goes to the location where the first multifunction peripheral 101 is installed to pick up the sheet on which the document data and the tint block pattern are combined and printed. Therefore, the information processing system 100 can provide the user 104 with the processing result of the function installed in the second multifunction peripheral 102 without causing the user 104 to operate the second multifunction peripheral 102.

### Second Embodiment

A second embodiment will be described with reference to FIG. 11. In the drawings, the same or equivalent elements are denoted by the same reference numerals, and redundant descriptions thereof are omitted. Components and processing having substantially the same functions as those in other embodiments will be referred to with the common reference numerals, and the descriptions thereof are omitted, and points different from other embodiments will be described.

The substitute determiner 214 according to the present embodiment searches for the second multifunction peripheral 102 when the execution function is the second function after the acceptor 203 accepts the operation of selecting the execution function.

FIG. 11 is a sequence diagram illustrating an example of an operation of the information processing system 100 according to the present embodiment.

When the acceptor 203 accepts a login operation by the user 104 who operates the first multifunction peripheral 101 in step S1101, the display controller 212 causes the displayer 202 to display the first function and the second function registered in the function management list 208 in step S1102. It is assumed that, at the time when the display controller 212 executes the processing of step S1102, the identification information of the second multifunction peripheral 102 is not registered in association with a priority in the substitute machine list 207 according to the present embodiment.

In step S1103, when the acceptor 203 accepts the operation of selecting the second function as the execution function, the substitute determiner 214 searches for the second multifunction peripheral 102 connected to the network 103. In step S1104, the substitute determiner 214 inquires of a first searched second multifunction peripheral 102c whether the execution function is installed in the second multifunction peripheral 102c.

In step S1105, when the substitute determiner 214 receives a response indicating that the execution function is not installed from the second multifunction peripheral 102c which has been searched first, the substitute determiner 214 inquires of a second multifunction peripheral 102d which has been searched second whether the execution function is installed in the second multifunction peripheral 102d in step S1106. In step S1107, when the substitute determiner 214 receives a response indicating that the execution function is installed from the second multifunction peripheral 102d which has been searched second, the processing controller 216 instructs the second multifunction peripheral 102d to execute the execution function in step S1108. Then, the controller 205 shifts the processing to step S1108. The processing from step S1108 to step S1110 is the same as the processing from step S708 to step S710 illustrated in FIG. 7, and thus the detailed description thereof will be omitted.

As described above, the information processing system 100 according to the present embodiment allows the user 104 to operate the first multifunction peripheral 101 without registering the second multifunction peripheral 102 in advance, and can provide the user 104 with the processing result of the function installed in the second multifunction peripheral 102.

### Third Embodiment

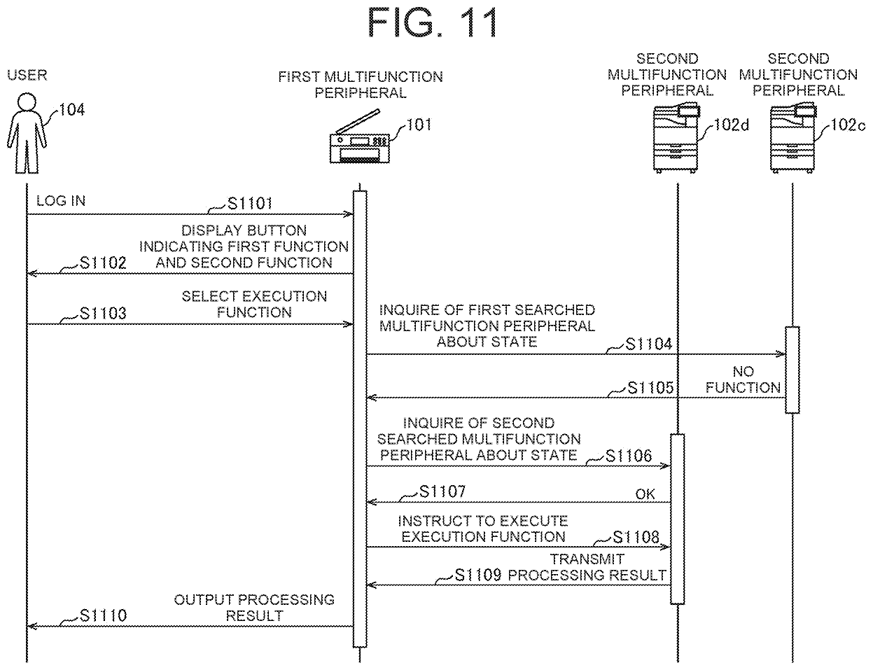

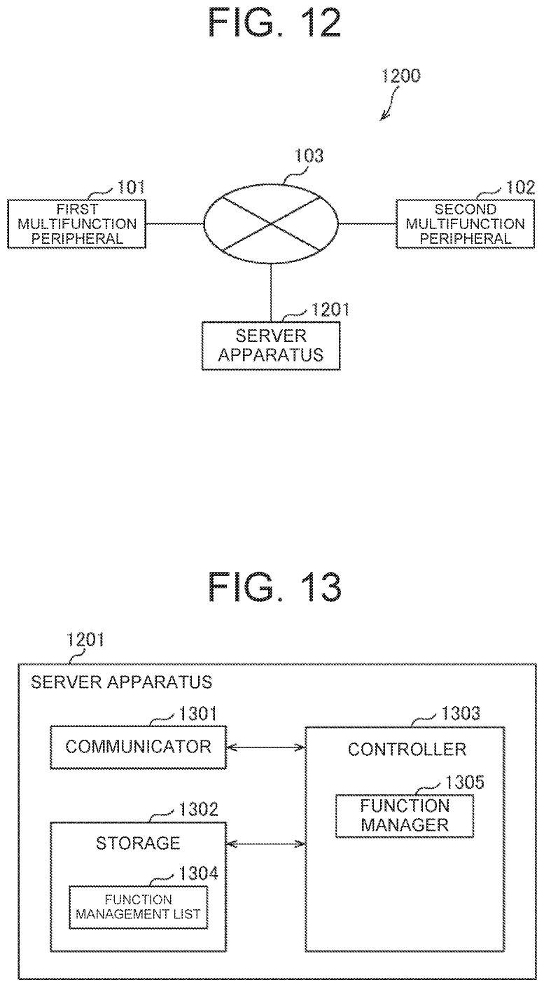

A third embodiment will be described with reference to FIGS. 12 to 15. In the drawings, the same or equivalent elements are denoted by the same reference numerals, and redundant descriptions thereof are omitted. Components and processing having substantially the same functions as those in other embodiments will be referred to with the common reference numerals, and the descriptions thereof are omitted, and points different from other embodiments will be described.

FIG. 12 is a block diagram illustrating an example of a configuration of an information processing system 1200 according to the present embodiment. The information processing system 1200 illustrated in FIG. 12 is different from the information processing system 100 illustrated in FIG. 1 in that the information processing system 1200 illustrated in FIG. 12 includes a server apparatus 1201. The server apparatus 1201 is connected to the first multifunction peripheral 101 and the second multifunction peripheral 102 via the network 103.

FIG. 13 is a block diagram illustrating an example of a configuration of the server apparatus 1201 according to the present embodiment. The server apparatus 1201 includes a communicator 1301, a storage 1302, and a controller 1303.

The communicator 1301 is an interface connected to the network 103.

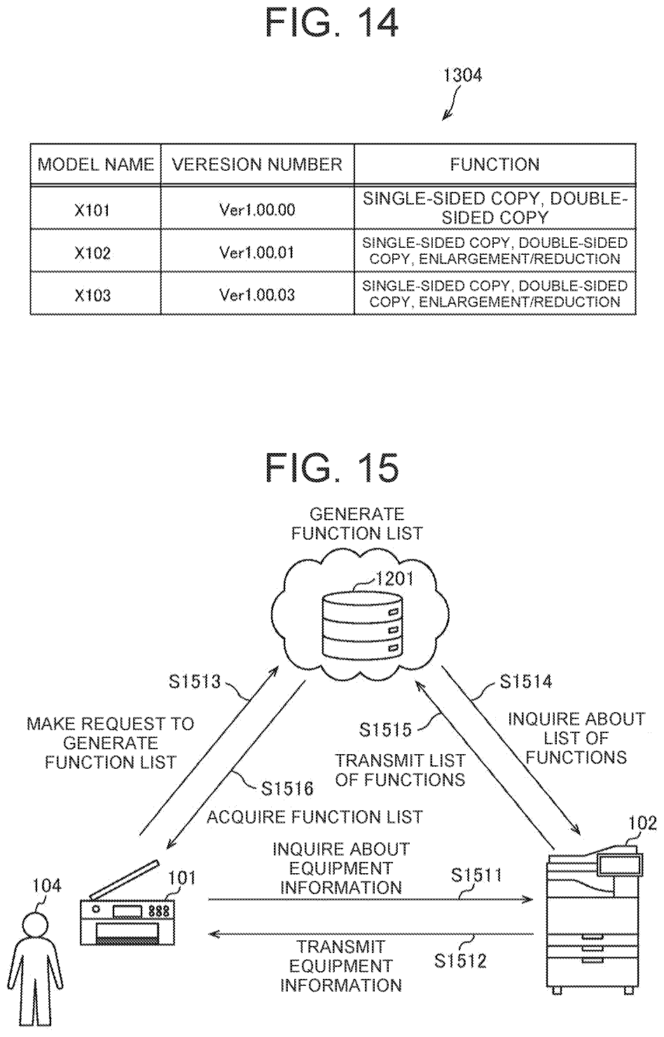

The storage 1302 is a recording medium capable of recording various kinds of data, programs, and the like. For example, the storage 1302 is configured with an HDD, an SSD, a semiconductor memory, or the like. The storage 1302 stores a function management list 1304 (see FIG. 14). In the function management list 1304, equipment information indicating the type of the second multifunction peripheral 102 and the functions installed in the second multifunction peripheral 102 are registered in association with each other.

The controller 1303 executes various processing in accordance with the programs and data stored in the storage 1302. For example, the controller 1303 is configured with a processor such as a CPU. The controller 1303 includes a function manager 1305.

The function manager 1305 acquires a list of functions registered in the installed function list 304 from the second multifunction peripheral 102. Then, the function manager 1305 registers the equipment information of the second multifunction peripheral 102 and the list of functions acquired from the second multifunction peripheral 102 in the function management list 1304 in association with each other.

FIG. 14 is a diagram illustrating an example of the function management list 1304. In the function management list 1304 illustrated in FIG. 14, a set of the model name and the version number of the second multifunction peripheral 102 indicates the equipment information of the second multifunction peripheral 102. In the function management list 1304 illustrated in FIG. 14, functions installed in each of the second multifunction peripheral 102 whose model name is X101, the second multifunction peripheral 102 whose model name is X102, and the second multifunction peripheral 102 whose model name is X103 are registered. For example, the function management list 1304 illustrated in FIG. 14 indicates that the second multifunction peripheral 102 whose model name is X101 and whose version number is Ver1.00.00 is provided with a single-sided copy function and a double-sided copy function.

FIG. 15 is a diagram illustrating an example of an operation in which the server apparatus 1201 generates the function management list 1304.

When the acceptor 203 accepts an operation of inputting the identification information of the second multifunction peripheral 102 on the screen 401 illustrated in FIG. 4A, the substitute register 211 associates the input identification information of the second multifunction peripheral 102 with the priority, and registers the identification information in the substitute machine list 207. In step S1511, the substitute register 211 inquires of the second multifunction peripheral 102 having the identification information registered in the substitute machine list 207 about the equipment information. In step S1512, the installed function list transmitter 311 responds to the first multifunction peripheral 101 with the equipment information. For example, the installed function list transmitter 311 responds to the first multifunction peripheral 101 with the equipment information indicating a set of the model name and the version number of the second multifunction peripheral 102.

In step S1513, the substitute register 211 transmits the equipment information transmitted from the second multifunction peripheral 102 in step S1512 and the identification information of the second multifunction peripheral 102 to the server apparatus 1201, and requests the server apparatus 1201 to generate the function management list 1304.

In step S1514, the function manager 1305 inquires of the second multifunction peripheral 102 having the identification information transmitted in step S1513 about a list of functions registered in the installed function list 304. In step S1515, the installed function list transmitter 311 responds to the server apparatus 1201 with a list of functions registered in the installed function list 304. The function manager 1305 registers the equipment information of the second multifunction peripheral 102 transmitted in step S1513 and the list of functions transmitted in step S1515 in the function management list 1304 in association with each other. As a result, for the second multifunction peripheral 102 having the identification information input by the user 104, the server apparatus 1201 can register the equipment information of the second multifunction peripheral 102 and the list of functions transmitted in step S1515 in the function management list 1304 in association with each other. Therefore, in the information processing system 100, the server apparatus 1201 can centrally manage the equipment information and the list of functions installed in the second multifunction peripheral 102 having the equipment information for the plurality of second multifunction peripherals 102. For example, the second multifunction peripheral 102 can automatically send a list of functions to the server apparatus 1201 at the time of function update, and the server apparatus 1201 can centrally manage the equipment information and the list of functions installed in the second multifunction peripheral 102 having the equipment information for the plurality of second multifunction peripherals 102. Further, in step S1516, the first multifunction peripheral 101 acquires the function list of the second multifunction peripheral 102 from the server apparatus 1201. That is, in the server apparatus 1201, in a case where the equipment information and the list of the functions installed in the second multifunction peripheral 102 having the equipment information are centrally managed for the plurality of second multifunction peripherals 102, the first multifunction peripheral 101 can acquire the function list of the second multifunction peripheral 102 by making an inquiry to the server apparatus 1201.

### Fourth Embodiment

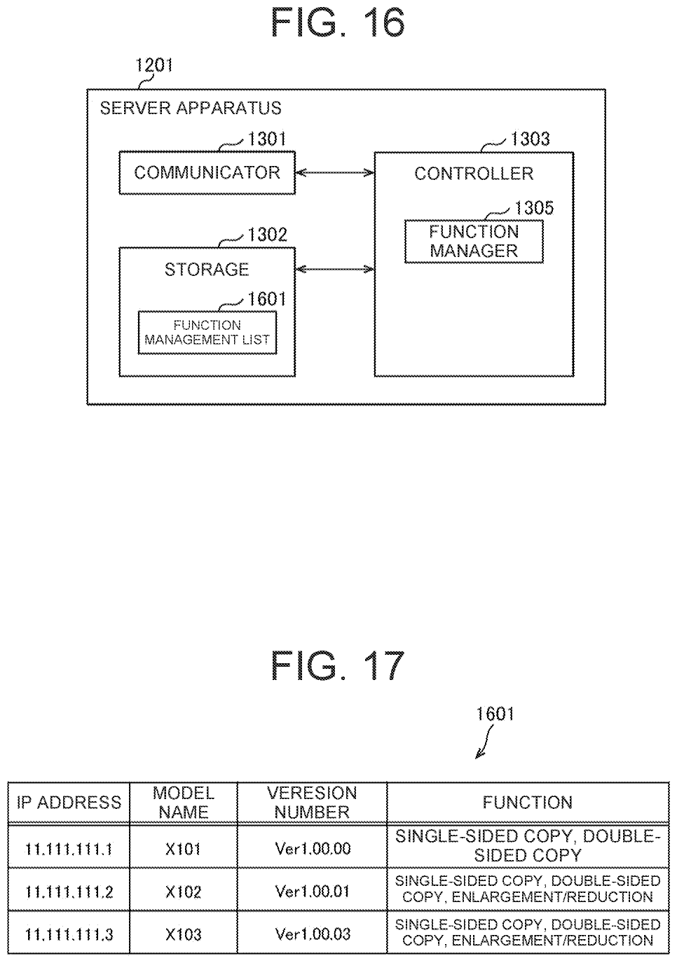

A fourth embodiment will be described with reference to FIGS. 16 to 18. In the drawings, the same or equivalent elements are denoted by the same reference numerals, and redundant descriptions thereof are omitted. Components and processing having substantially the same functions as those in other embodiments will be referred to with the common reference numerals, and the descriptions thereof are omitted, and points different from other embodiments will be described.

The installed function list transmitter 311 according to the present embodiment transmits the installed function list 304 to the server apparatus 1201.

FIG. 16 is a block diagram illustrating an example of a configuration of the server apparatus 1201 according to the present embodiment. The server apparatus 1201 illustrated in FIG. 16 is different from the server apparatus 1201 illustrated in FIG. 13 in that the server apparatus 1201 illustrated in FIG. 16 stores a function management list 1601 in the storage 1302.

FIG. 17 is a diagram illustrating an example of the function management list 1601. In the function management list 1601, the identification information of the second multifunction peripheral 102, the equipment information of the second multifunction peripheral 102, and the functions installed in the second multifunction peripheral 102 are associated with one another. The identification information of the second multifunction peripheral 102 indicated by the function management list 1601 is the same as the identification information used for designating the priority in the first multifunction peripheral 101. That is, the identification information of the second multifunction peripheral 102 indicated by the function management list 1601 is the same as the identification information associated with the priority in the substitute machine list 207. For example, the identification information of the second multifunction peripheral 102 is an IP address assigned to the second multifunction peripheral 102.

In the function management list 1601 illustrated in FIG. 17, functions installed in each of the second multifunction peripheral 102 whose model name is X101, the second multifunction peripheral 102 whose model name is X102, and the second multifunction peripheral 102 whose model name is X103 are registered. For example, the function management list 1601 illustrated in FIG. 17 indicates that, for the second multifunction peripheral 102 whose model name is X101 and whose version number is Ver1.00.00, the IP address indicating the identification information of the second multifunction peripheral 102 is 11.111.111.1 and that the second multifunction peripheral 102 is provided with the single-sided copy function and the double-sided copy function.

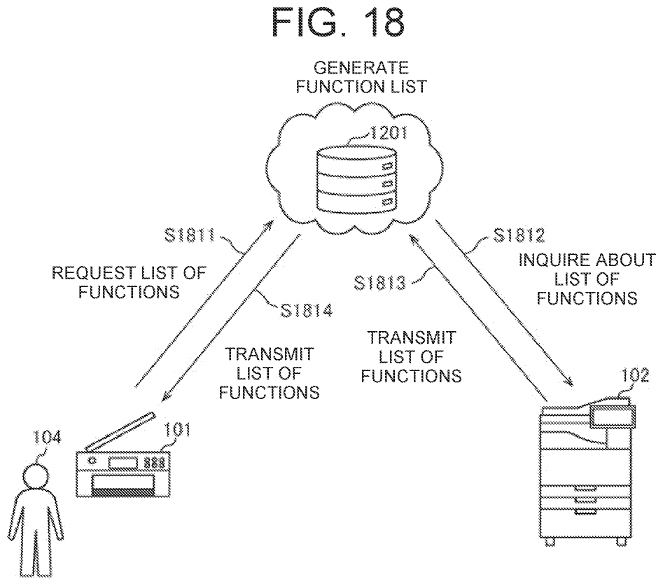

FIG. 18 is a diagram illustrating an example of an operation in which the server apparatus 1201 generates the function management list 1601.

When the acceptor 203 accepts, on the screen 401 illustrated in FIG. 4A, an operation of inputting the identification information of the second multifunction peripheral 102 to be registered, the substitute register 211 associates the input identification information of the second multifunction peripheral 102 with the priority, and registers the identification information in the substitute machine list 207. In step S1811, the substitute register 211 requests the server apparatus 1201 to provide a list of functions of the second multifunction peripheral 102 having the input identification information.

In step S1812, the function manager 1305 inquires of the second multifunction peripheral 102, which has been requested to provide the list of functions in step S1811, about the list of functions registered in the installed function list 304. In step S1813, the installed function list transmitter 311 responds to the server apparatus 1201 with the equipment information of the second multifunction peripheral 102 and a list of functions registered in the installed function list 304. The function manager 1305 registers the identification information of the second multifunction peripheral 102, the equipment information of the second multifunction peripheral 102 transmitted in step S1813, and the list of functions transmitted in step S1813 in the function management list 1601 in association with one another.

In step S1814, the function manager 1305 responds to the first multifunction peripheral 101 with a list of functions registered in the function management list 1601 for the second multifunction peripheral 102 having the input identification information. The substitute register 211 registers, in the function management list 208, the first function, the list of functions transmitted from the server apparatus 1201, the input identification information, and the priority associated with the identification information in the substitute machine list 207 in association with one another.

As described above, the information processing system 1200 according to the present embodiment exhibits the same effect as the information processing system 1200 according to the third embodiment, and the first multifunction peripheral 101 can acquire a list of functions installed in the second multifunction peripheral 102 without inquiring of the second multifunction peripheral 102 about the equipment information.

Each processing executed in the above embodiments is not limited to the processing mode exemplified in each embodiment. The above-described functional blocks may be implemented by using either a logic circuit (hardware) formed in an integrated circuit or the like or software using a CPU. Each processing executed in the above embodiments may be executed by a plurality of computers. For example, some of the processing executed by each functional block of the controller 205 of the first multifunction peripheral 101, the controller 303 of the second multifunction peripheral 102, and the controller 1303 of the server apparatus 1201 may be executed by another computer, or all of the processing may be shared and executed by a plurality of computers.

The present disclosure is not limited to the above-described embodiments, and may be replaced with a configuration which is substantially the same as the configuration illustrated in the above-described embodiments, a configuration which exhibits the same operation and effect, or a configuration which can achieve the same object. In the present disclosure, an embodiment obtained by appropriately combining the technical measures respectively disclosed in different embodiments is also included in the technical scope of the present disclosure. Furthermore, a new technical feature can be formed by combining the technical measures respectively disclosed in each embodiment.

What is claimed is:

1. An information processing system comprising:
an acceptor that accepts an operation of selecting an execution function from a first function installed in a first multifunction peripheral and a second function not installed in the first multifunction peripheral; and
a processing controller that executes the execution function in the first multifunction peripheral when the execution function is the first function, and instructs a second multifunction peripheral in which the second function is installed to execute the execution function when the execution function is the second function.

2. The information processing system according to claim 1, further comprising a substitute register that registers a function installed in the second multifunction peripheral and the second multifunction peripheral in association with each other.

3. The information processing system according to claim 1, further comprising:
a displayer; and
a display controller that causes the displayer to display the first function and the second function in a distinguishable manner.

4. The information processing system according to claim 3, wherein the display controller causes the displayer to display, for the second function, a function that can be operated in the first multifunction peripheral and a function that cannot be operated in the first multifunction peripheral in a distinguishable manner.

5. The information processing system according to claim 3, wherein the display controller causes the displayer to display, for the second function, a function that requires an operation in the second multifunction peripheral and a function that does not require an operation in the second multifunction peripheral in a distinguishable manner.

6. The information processing system according to claim 1, further comprising a determiner that determines whether the execution function is the first function.

7. The information processing system according to claim 1, further comprising a substitute determiner that determines whether there is the second multifunction peripheral when the execution function is the second function.

8. The information processing system according to claim 1, further comprising an error determiner that determines whether the first multifunction peripheral is capable of executing the execution function when the execution function is the first function.

9. The information processing system according to claim 3, wherein the display controller causes the displayer to display a function that can be executed in the first multifunction peripheral and a function that cannot be executed in the first multifunction peripheral in a distinguishable manner.

10. The information processing system according to claim 7,
wherein when the execution function is the second function or when the execution function is the first function and the first multifunction peripheral is not capable of executing the execution function, the substitute determiner determines whether there is a multifunction peripheral capable of executing the execution function, and
wherein the processing controller instructs the multifunction peripheral capable of executing the execution function to execute the execution function.

11. The information processing system according to claim 1, wherein the processing controller notifies a location where the second multifunction peripheral is installed when the execution function requires an operation in the second multifunction peripheral.

12. The information processing system according to claim 1, wherein when the execution function can be executed and an operation is necessary in a plurality of second multifunction peripherals, the processing controller instructs a second multifunction peripheral installed closest to the first multifunction peripheral among the plurality of second multifunction peripherals to execute the execution function.

13. A multifunction peripheral cooperation method comprising:
accepting an operation of selecting an execution function from a first function installed in a first multifunction peripheral and a second function not installed in the first multifunction peripheral; and
executing the execution function in the first multifunction peripheral when the execution function is the first function, and instructing a second multifunction peripheral in which the second function is installed to execute the execution function when the execution function is the second function.

14. A non-transitory computer-readable medium storing a program that causes a computer to execute:
a function of accepting an operation of selecting an execution function from a first function installed in a first multifunction peripheral and a second function not installed in the first multifunction peripheral; and
a function of performing the execution function in the first multifunction peripheral when the execution function is the first function, and instructing a second multifunction peripheral in which the second function is installed to execute the execution function when the execution function is the second function.
